(19) United States
(12) Patent Application Publication
(10) Pub. No.: US 2016/0253724 A1
(43) Pub. Date: Sep. 1, 2016

(54) System and Method for Co-Shipment Recommendation

(71) Applicant: eBay Inc., San Jose, CA (US)

(72) Inventor: Lakshmi Narasimhan, Bangalore (IN)

(21) Appl. No.: 14/633,254

(22) Filed: Feb. 27, 2015

(51) Int. Cl. G06Q 30/06; G06F 17/30

(52) U.S. Cl. CPC G06Q 30/0613; G06F 17/3053; G06F 17/3087

(57) ABSTRACT

A system and method for generating a co-shipment recommendation is described. The system identifies a seller seeking a co-shipper in an online marketplace. The system accesses marketplace data to identify one or more other sellers listing a same item as the seller. The system also accesses performance data from the identified one or more other sellers. The identified one or more other sellers are ranked as co-shippers based on the marketplace and performance data. A recommendation for co-shippers is generated to the seller based on the ranked identified one or more other sellers. The system receives a selection of a recommended co-shipper from the seller and forms a co-shipping relationship between the selected co-shipper and the seller. The selected co-shipper is to ship to the same item to a buyer of the seller.

### TECHNICAL FIELD

This application relates generally to the field of computer technology and, in a specific example embodiment, to a method and system for co-shipment recommendation.

### BACKGROUND

Online marketplaces include many sellers listing items for sale. Buyers buy these items and sellers ship the items to the buyers upon receipt of payment. Many buyers are located across the country or across many geographical regions. For a seller offering free shipping, the shipping cost may be lower to ship to a buyer geographically closer to the seller than to another buyer further away from the seller. Furthermore, a shipping duration increases with the shipping distance.

### BRIEF DESCRIPTION OF THE DRAWINGS

The present application is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 shows a block diagram illustrating one example embodiment of a marketplace application;

FIG. 3 shows a block diagram illustrating one example embodiment of a co-shipment recommendation application;

FIG. 4 shows a block diagram illustrating one example embodiment of a co-shipper recommendation engine;

FIG. 5 shows a block diagram illustrating one example embodiment of a relationship management engine;

FIG. 6A shows a block diagram illustrating one example of a co-shipper network;

FIG. 6B shows a block diagram illustrating one example of an operation of a co-shipper;

FIG. 6C shows a block diagram illustrating another example of an operation of a co-shipper;

FIG. 7 shows a flow diagram illustrating one example embodiment of a method for generating a recommendation for one or more co-shippers;

FIG. 8 shows a flow diagram illustrating one example embodiment of a method for forming a co-shipping agreement between a seller and a co-shipper;

FIG. 9 shows a flow diagram illustrating one example embodiment of a method for adjusting a co-shipper compensation based on performance data of the co-shipper; and

FIG. 10 shows a diagrammatic representation of machine in the example form of a computer system within which a set of instructions may be executed to cause the machine to perform any one or more of the methodologies discussed herein.

### DETAILED DESCRIPTION

Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for generating a co-shipment recommendation is described. Many sellers provide fixed-rate national or international shipping, or otherwise would benefit from reducing average shipping costs and delivery times by being able to ship from a location nearer to the buyer rather than a central location of the seller. Large businesses deal with this problem by maintaining multiple warehouses of goods, so that items can be shipped to the buyer from the nearest warehouse. Smaller businesses (SMBs) with lower volumes cannot justify the overhead of these additional shipping centers.

SMBs in different locations can benefit by serving as co-shippers. In a co-shipping arrangement, one SMB uses its existing location to ship goods to nearby customers of another SMB, and (optionally) vice versa. A central site (e.g., an ecommerce site) may provide matching services between SMBs to facilitate co-shipping. For example, if the central site has access to information about goods sold by each SMB, customer locations for each order, and delays incurred in processing orders, then a recommendation can be generated for a co-shipper that is not in direct competition, is near to customers, and handles orders promptly. In one example embodiment, the present system recommends co-shippers to an SMB and helps manage the relationship between the SMB and the co-shippers. Potential co-shippers can be ranked based on a distance from a center of a cluster of customers, timeliness in shipping, customer feedback, and other criteria.

The potential co-shippers are presented to the SMB or automatically selected for the SMB by the central site. When an order is placed by a customer within the shipping area of the co-shipper, the central site can automatically inform the co-shipper and divide the amount received from the buyer appropriately between the seller and the co-shipper. In another example embodiment, the co-shipping agreement (CSA) may include a specific agreement between two sellers to ship products for each other, rather than as a distributed fulfillment service. For example, while Company A might be best located to serve as a fulfillment center for Company B, Company A may be in a poor location to aid Company B. Company C may be the second-choice shipper for Company A, while Company A is also a highly-ranked option for Company C. Accordingly, the system may generate a recommendation for Companies A and C to form a CSA.

In one example embodiment, the system identifies a seller seeking a co-shipper in an online marketplace. The system accesses marketplace data to identify one or more other sellers listing a same item as the seller. The system also accesses performance data from the identified one or more other sellers. The identified one or more other sellers are ranked as co-shippers based on the marketplace and performance data. A recommendation for co-shippers is generated to the seller based on the ranked identified one or more other sellers. The system receives a selection of a recommended co-shipper from the seller and forms a co-shipping relationship between the selected co-shipper and the seller. The selected co-shipper is to ship the same item to a buyer of the seller.

The co-shipper recommendation engine may receive a request from the seller to identify the one or more other sellers in the online marketplace who will has the same item in stock as the one or more other sellers and commonly sold by the seller and the one or more other sellers.

The co-shipper recommendation engine may identify the one or more other sellers within a geographic boundary associated with previous buyers of the seller. In another example, the co-shipper recommendation engine identifies the one or more other sellers having performance data exceeding a performance threshold. The performance data may include customer feedback and shipping timeliness.

The co-shipper recommendation engine identifies the one or more other sellers having marketplace data exceeding a marketplace threshold. The marketplace data may include inventory size for the same item sold by the seller, sales volume, geography of customer demands for the same item, and existing shipping relationships with the seller.

In another example, the co-shipper recommendation engine computes a co-shipment ranking score for each identified one or more sellers based on the marketplace and performance data and generates a recommendation for co-shippers based on the co-shipment ranking score. The relationship management engine may access performance data of the selected co-shipper in the online marketplace and adjust the co-shipping relationship between the selected co-shipper and the seller based on the performance data of the selected co-shipper. For example, adjusting may mean ending the co-shipping relationship between the selected co-shipper and the seller based on the performance data of the selected co-shipper falling below a performance threshold. The co-shipping relationship may be strengthened with a higher payout (or share) to the co-shipper based on the performance data of the selected co-shipper exceeding a performance threshold.

In another example, the relationship management engine divides an amount received from the buyer of the item shipped by the selected co-shipper between the selected co-shipper and the seller.

### System Architecture

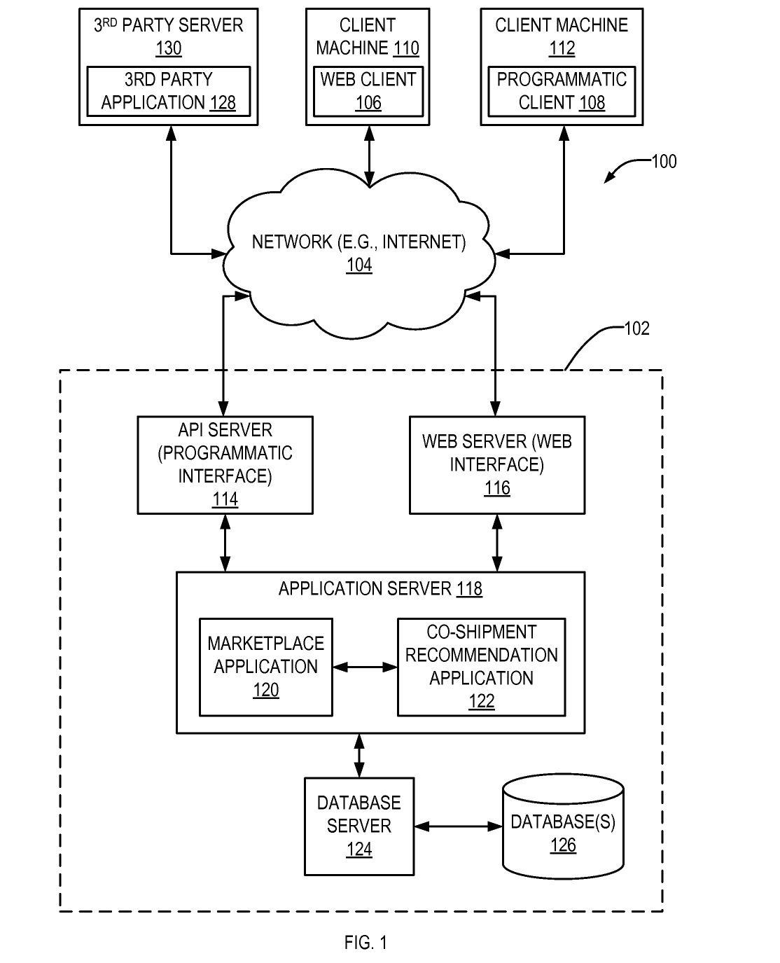

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a marketplace application 120 and a co-shipment recommendation application 122, may provide server-side functionality, via a network 104 (e.g., the Internet) to one or more clients. The one or more clients may include users that utilize the network system 100 and, more specifically, the marketplace application 120 and the co-shipment recommendation application 122, to exchange data over the network 104. These transactions may include transmitting, receiving (communicating), and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, real time synchronization of financial journals, and so forth.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments the client machines 110, 112, or third party server 130 may be associated with a buyer, a seller, a third party electronic commerce platform, a payment service provider, a shipping service provider, or a financial institution system, each in communication with a network-based publisher 102 and optionally each other. The buyers and sellers may be any one of individuals, merchants, or service providers, among other things.

Turning specifically to the marketplace application 120 and the co-shipment recommendation application 122, an application program interface (API) server 114 and the web server 116 are coupled to, and provide programmatic and web interfaces respectively to, one or more application servers 118. The application server 118 hosts one or more marketplace applications 120 and the co-shipment recommendation application 122. The application server 118 is, in turn, shown to be coupled to one or more database servers 124 that facilitate access to one or more database(s) 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods or services (e.g., for sale) published on the marketplace application 120.

In one embodiment, the co-shipment recommendation application 122 includes a system and a method for generating recommendations for co-shippers and managing relationships between co-shippers. The co-shipment recommendation application 122 will be discussed in more detail in connection with FIG. 3 below.

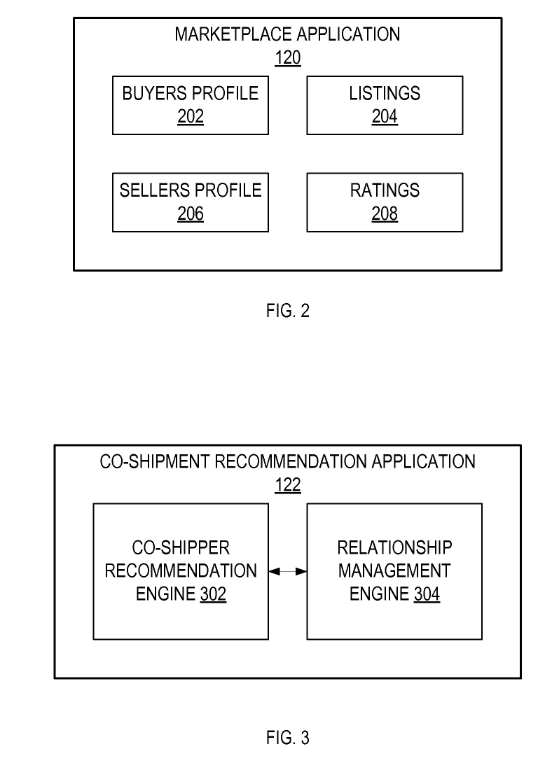

FIG. 2 shows a block diagram illustrating one example embodiment of the marketplace application 120. The marketplace application 120 includes, for example, a buyers profile module 202, a sellers profile module 206, a listings module 204, and a ratings module 208.

The buyers profile module 202 is configured to generate and store profiles of buyers of the marketplace application 120. For example, the profiles of the buyers may include names, addresses (including shipping addresses), and transaction history.

The sellers profile module 204 is configured to generate and store profiles of sellers of the marketplace application 120. For example, the profiles of the seller may include names, addresses (including shipping addresses), and transaction history.

The listings module 206 is configured to generate and store listings from the sellers. The listings may identify items for sale in the marketplace application 120.

The ratings module 208 is configured to generate and store ratings, including feedback ratings of buyers and sellers. In another embodiment, the ratings module 208 may also be configured to generate transaction volume and shipping volume data on the marketplace application 120 or any other online marketplace. In one example, the co-shipping system cross pollinates seller feedback related to shipping. For example, if Seller B shipped items on behalf of Seller A, any rating related to shipping would be assigned to Seller B.

FIG. 3 shows a block diagram illustrating one example embodiment of the co-shipment recommendation application 122. The co-shipment recommendation application 122 comprises a co-shipper recommendation engine 302 and a relationship management engine 304.

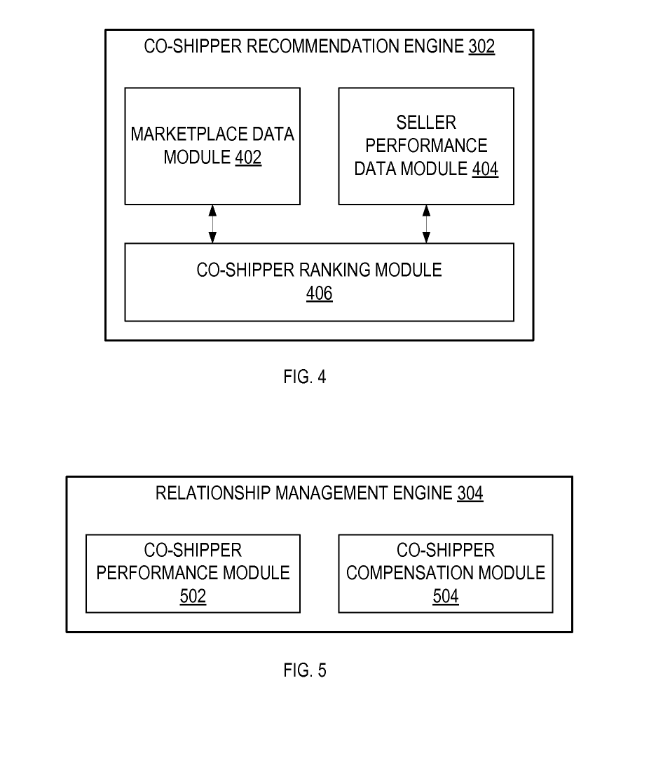

The co-shipper recommendation engine 302 generates recommendations for a network of co-shippers for a seller in the online marketplace. For example, a seller of the online marketplace may form and establish relationships with other sellers from the online marketplace or any other marketplaces to generate the network of co-shippers. In other words, a co-shipper from the network of co-shippers may include a second seller from the online marketplace or another marketplace able to fulfill a shipment of an item corresponding to a listing on behalf of the seller. An example embodiment of the co-shipper recommendation engine 302 is described in more details below with respect to FIG. 4. In an embodiment, a seller requests a co-shipper. The system accesses marketplace data to identify other sellers of the seller's same item and generates a recommendation for one or more other sellers in the online marketplace (or other marketplaces) as potential co-shippers for the seller to form his/her network of co-shippers.

The relationship management engine 304 accesses performance data of the co-shippers and the seller to adjust the relationship of the co-shippers. For example, a co-shipper may be dropped for a seller based on a poor shipping performance (e.g., too many delays) of the co-shipper. An example embodiment of the relationship management engine 304 is described in more details below with respect to FIG. 5.

FIG. 4 shows a block diagram illustrating one example embodiment of the co-shipper recommendation engine 302. The co-shipper recommendation engine 302 includes, for example, a marketplace data module 402, a seller performance data module 404, and a co-shipper ranking module 406.

The marketplace data module 402 accesses the seller's data from the marketplace application 120. For example, the seller's data may include a seller's size, sales volume, inventory, distance to clusters of customers of other sellers, goods sold, geographic location, and so forth.

The seller performance data module 404 accesses data related to the sales and shipping performance of other sellers in the marketplace application 120. For example, the performance data may include timeliness of shipping (e.g., how fast an item shipment is fulfilled), customer feedback ratings from buyers, rating of the other seller in specific categories, rating the delivery performance of the other seller, rating based on the disputes initiated against the other seller, and the like.

The co-shipper ranking module 406 identifies other sellers as potential co-shippers for a seller based on marketplace data of the other sellers. For example, the co-shipper ranking module 406 identifies other sellers with the same item in inventory listed for sale by the seller in the online marketplace. In other words, the co-shipper ranking module 406 verifies that at least one item in the inventory of a co-shipper (e.g., a selected other seller) matches an item listed for sale by the seller requesting a co-shipper.

The co-shipper ranking module 406 filters all sellers in the online marketplace to sellers with the same item in inventory. The co-shipper ranking module 406 then further filters the remaining sellers based on distance to customer locations of the seller requesting a co-shipper. For example, if the seller has a lot of customers around Boston based on past sales history, the co-shipper ranking module 406 further identifies sellers having the same item in inventory and with a geographic location within a preset distance of Boston. For instance, the preset distance may include a shipping distance zone (e.g., same day delivery, two-day delivery). The co-shipper ranking module 406 may then rank the remaining sellers as potential co-shippers based on performance data of the sellers. For example, sellers with a highest customer feedback rating may be ranked higher in the list of recommended sellers as co-shippers.

The co-shipper ranking module 406 generates a list of suggested sellers as co-shippers to the seller based on marketplace data and performance data of the suggested sellers. For example, the co-shipper ranking module 406 may generate suggested sellers who have a high volume of transactions and at least a predetermined number of matching items in their respective inventory, and are not in direct competition with the seller. In one example, inventories or listings of the sellers are compared to determine whether they are not in direct competition with one another. In other examples, historical transactions, sales volumes for items and categories of the respective sellers are compared to determine whether they are competitors. The co-shipper ranking module 406 determines that sellers are not competitors is their respective sales volume for a common item does not exceed a predefined sales volume threshold.

After the co-shipper ranking module 406 generates the recommended sellers, the seller may confirm and choose to send requests to one or more recommended sellers to join his/her network of co-shippers. A connection request is sent to the selected co-shipper who then needs to accept the request in order to be part of the seller's co-shipper network.

Apart from sending requests to sellers in the same online marketplace, the seller can also send requests to sellers in other online marketplaces, to business entities that only fulfill orders, or to other business entities that have a separate ecommerce identity on the Internet. In that case, the seller may specify email addresses of such business entities that are not associated with marketplace application 120 and send requests to them. Upon receiving the request, these business entities may similarly wish to join the seller's co-shipper network by going through a registration flow to register as a user in the marketplace application 120 and accept the request.

FIG. 5 shows a block diagram illustrating one example embodiment of the relationship management engine 304. The relationship management engine 304 includes a co-shipper performance module 502 and a co-shipper compensation module 504.

The co-shipper performance module 502 tracks performance data related to the co-shipper handling of fulfilling a shipment of an item for the seller. The performance data may include the timeliness in shipping the item to the buyer for the seller and the buyer's feedback rating on shipping.

The co-shipper compensation module 504 selects a co-shipper from the network of co-shippers based, in part, on distance to customers. For example, if there are several co-shippers willing to fulfill the order on behalf of the seller, the seller may choose a particular co-shipper to fulfill the order. In one embodiment, the seller may provide the selection criteria to the system and have the system automatically select a co-shipper for fulfilling a transaction. One example criteria for selection can be the price at which the co-shipper offers to have the order fulfilled; for example, the co-shipper offering to fulfill at the lowest price can be selected. Another example of criteria can be the speed of delivery. In other example, a co-shipper that commits to having the order fulfilled the fastest may be selected. A seller can setup the selection criteria to be a combination of criteria such as fulfillment price, delivery time commitment, and so forth.

The co-shipper compensation module 504 determines compensation for the seller upon verification of receipt of the item by the buyer. In one embodiment, the co-shipper compensation module 504 receives funds from the buyer for the item shipped by the co-shipper. The co-shipper compensation module 504 divides the proceeds from the buyer between the seller and the co-shipper. For example, the compensation to the co-shipper may include a commission for shipping the item for the seller. In another embodiment, the co-shipper compensation module 504 tallies the number of times a co-shipper has shipped on behalf of a seller and credits the co-shipper based on a reciprocity agreement between the seller and the co-shipper. For example, if the co-shipper has shipped two times for the seller, then the seller now has to ship two times for the co-shipper.

The co-shipper compensation module 504 also determines compensation for the trusted fulfillment agent upon verification of the fulfillment of the shipment of the item. In one embodiment, the marketplace application 120 makes a payment of the amount paid by the buyer to the seller's payment account, holding the funds or making the funds inaccessible by the seller until the delivery of shipment is confirmed by the buyer or the system. In such cases, upon verification of fulfillment of the order, the compensation amount agreed to between the seller and the co-shipper may be transferred to the co-shipper's account, although it may still be held inaccessible by the co-shipper.

In another example, the co-shipper compensation module 504 adjusts a compensation agreement based on the performance of the co-shipper. For example, if the co-shipper fails to ship on time for a number of times, the co-shipper compensation module 504 drops the co-shipper as a part of the co-shipper network of the seller. In another example, if the co-shipper performs poorly, the compensation or commission to the co-shipper may be reduced.

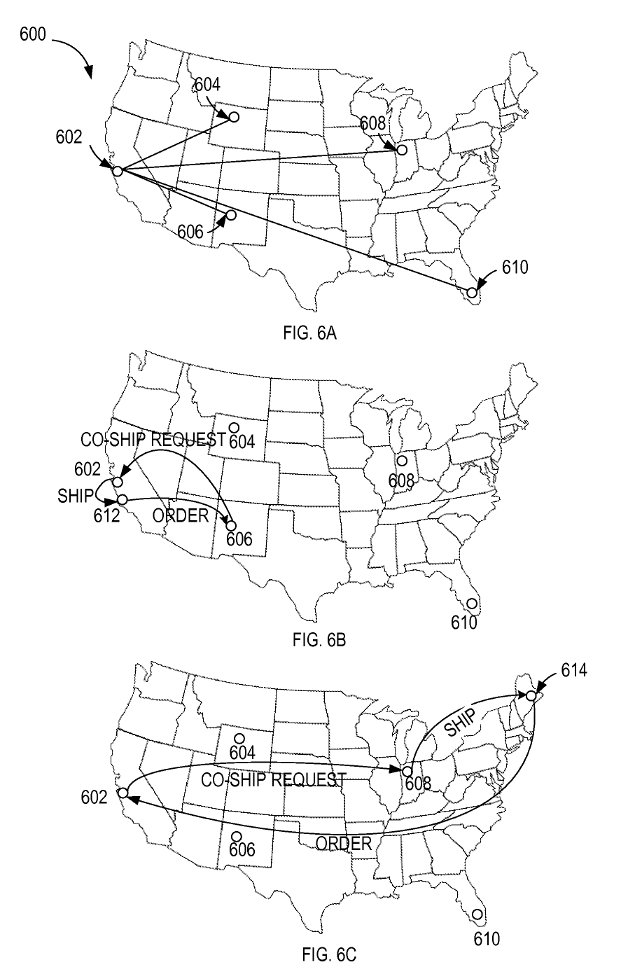

FIG. 6A shows a block diagram illustrating one example of a co-shipper network 600. A seller 602 may form a network with other co-shippers 604, 606, 608, and 610 based on marketplace data and performance data set by the seller 602 as recommended by the co-shipment recommendation application 122. In one embodiment, co-shippers 604, 606, 608, and 610 have the same item as in a listing of the seller 602 in their corresponding inventory. In another embodiment, each item sold by the seller 602 may be associated with a different network of co-shippers.

FIG. 6B shows a block diagram illustrating one example of an operation of a co-shipper. A buyer 612 submits an order to the seller 606. Because the co-shipper 602 is geographically located closest to the buyer 612, the seller 606 generates a co-ship request to the co-shipper 602. Co-shipper 602 fulfils the order and ships the item to the buyer 612.

FIG. 6C shows a block diagram illustrating one example of another operation of a co-shipper. A buyer 614 submits an order to the seller 602. Because the co-shipper 608 is geographically located closest to the buyer 612, the seller 602 generates a co-ship request to the co-shipper 608. Co-shipper 608 fulfils the order and ships the item to the buyer 612.

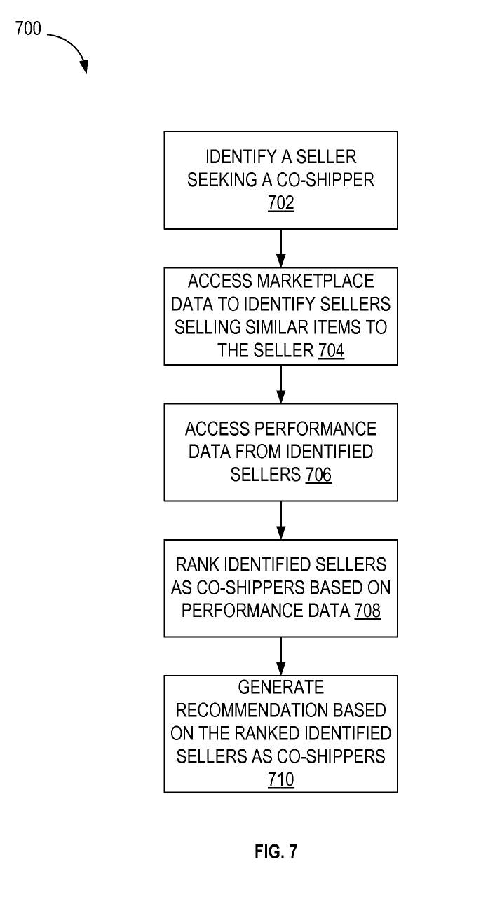

FIG. 7 shows a flow diagram 700 illustrating one example embodiment of a method for a co-shipment recommendation. At operation 702, the co-shipment recommendation application 122 identifies a seller seeking a co-shipper. In one example embodiment, operation 702 may be implemented using the co-shipper recommendation engine 302. The co-shipment recommendation application 122 generates a user interface (e.g., webpage) that displays and presents identifiers of recommended co-shippers to the seller after the co-shippers have been identified. The user interface is configured to receive information from the seller with respect to the request to identify co-shippers. The request may include identifying co-shippers located in geographical proximity to the clients of the seller.

At operation 704, the co-shipment recommendation application 122 accesses marketplace data to identify other sellers selling similar items as the seller. In one example embodiment, operation 704 may be implemented using the co-shipper recommendation engine 302.

At operation 706, the co-shipment recommendation application 122 accesses performance data from the identified sellers. In one example embodiment, operation 706 may be implemented using the co-shipper recommendation engine 302.

At operation 708, the co-shipment recommendation application 122 ranks the identified sellers as co-shippers based on performance data. In one example embodiment, operation 708 may be implemented using the co-shipper recommendation engine 302.

At operation 710, the co-shipment recommendation application 122 generates a recommendation based on the ranked identified sellers as co-shippers. For example, the co-shipment recommendation application 122 generates a list of the top five identified sellers as recommended co-shippers. The seller has the option to check or select which sellers to request as co-shippers. Upon receipt of the request, the corresponding potential co-shippers may agree to the request from the seller to act as co-shipper. The co-shipper compensation module 504 implements a co-shipment agreement that includes a compensation based model where the co-shipper and the seller split the proceeds from the buyer. In another example, the co-shipment agreement may include a reciprocity agreement where the co-shipper and the seller agree to ship on each other's behalf. The reciprocity agreement may include a credit system that credits each co-shipper for a co-shipment for a seller. In one example embodiment, operation 710 may be implemented using the relationship management engine 304.

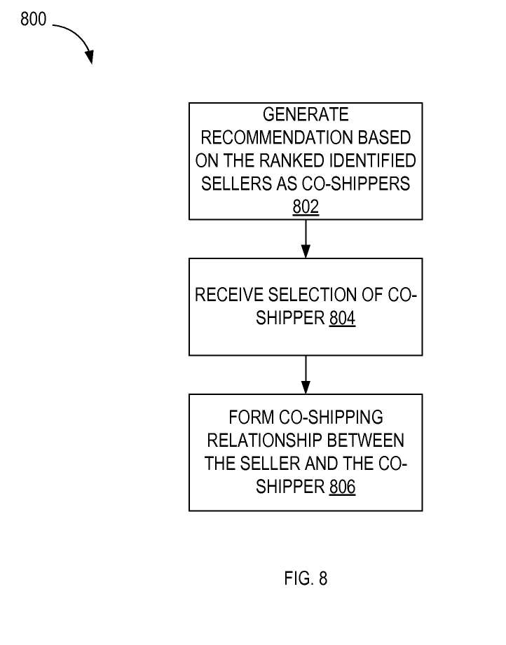

FIG. 8 shows a flow diagram 800 illustrating one example embodiment of a method for forming a co-shipment agreement between a seller and a co-shipper. At operation 802, the shipment recommendation application 122 generates a recommendation based on the ranked identified sellers as co-shippers. At operation 804, the shipment recommendation application 122 receives a selection of a co-shipper from the seller. At operation 806, the seller and the co-shipper form a co-shipper service agreement that may be implemented using the co-shipper compensation module 504. The network of co-shippers is then formed based on the seller's selection of suggested co-shippers (and acceptance from the co-shippers).

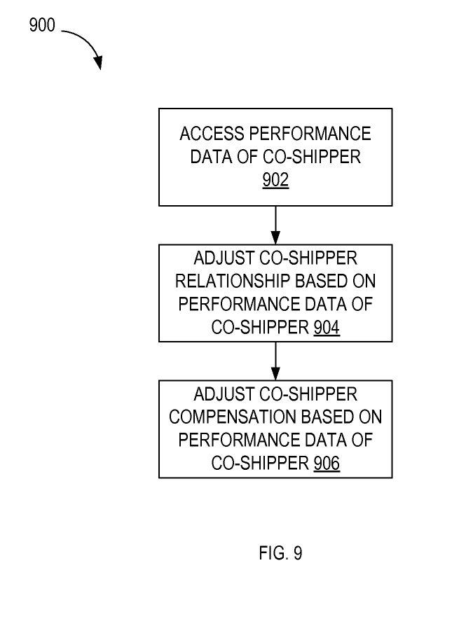

FIG. 9 shows a flow diagram 900 illustrating one example embodiment of a method for adjusting compensation for a co-shipper. At operation 902, the relationship management engine 304 accesses performance data of a co-shipper. At operation 904, the relationship management engine 304 adjusts the co-shipper agreement based on performance data of co-shipper. At operation 906, the relationship management engine 304 adjusts co-shipper compensation based on performance data of the co-shipper.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed in various example embodiments.

### Example Computer System

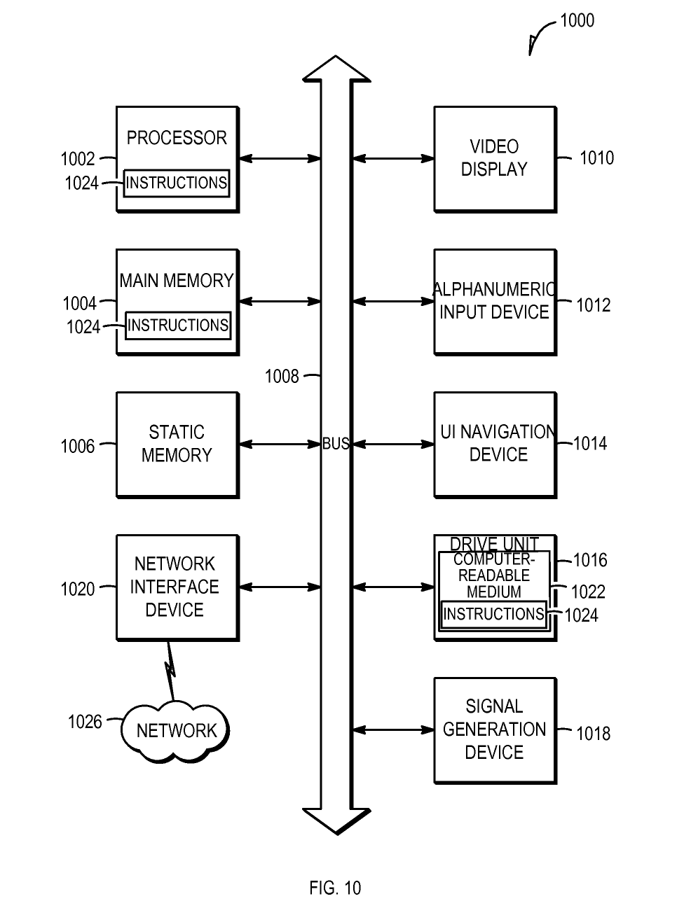

FIG. 10 shows a diagrammatic representation of a machine in the example form of a computer system 1000 within which a set of instructions 1024 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 1024 (sequential or otherwise) that specify actions to be taken by that machine. Further, while only a single machine is illustrated, the term “machine” shall also be taken to include any collection of machines that individually or jointly execute a set (or multiple sets) of instructions 1024 to perform any one or more of the methodologies discussed herein.

The example computer system 1000 includes a processor 1002 (e.g., a central processing unit (CPU), a graphics processing unit (GPU, or both)), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a UI navigation device 1014 (e.g., a mouse), a disk drive unit 1016, a signal generation device 1018 (e.g., a speaker), and a network interface device 1020.

The drive unit 1016 includes a computer-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 or within the processor 1002 during execution thereof by the computer system 1000, with the main memory 1004 and the processor 1002 also constituting machine-readable media.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and 4G networks). The term “transmission medium” shall be taken to include any intangible medium that is capable of storing, encoding, or carrying instructions for execution by the machine, and includes digital or analog communications signals or other intangible medium to facilitate communication of such software.

While the computer-readable medium 1022 is shown in an example embodiment to be a single medium, the term “computer-readable medium” should be taken to include a single medium or multiple media (e.g., a centralized or distributed database, and/or associated caches and servers) that store the one or more sets of instructions 1024. The term “computer-readable medium” shall also be taken to include any medium that is capable of storing, encoding, or carrying a set of instructions 1024 for execution by the machine and that cause the machine to perform any one or more of the methodologies of the present disclosure, or that is capable of storing, encoding or carrying data structures utilized by or associated with such a set of instructions 1024. The term “computer-readable medium” shall, accordingly, be taken to include, but not be limited to, solid-state memories, optical media, and magnetic media.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system for co-shipment recommendation comprising:
at least one hardware processor comprising a co-shipper recommendation engine,
the co-shipper recommendation engine configured to:
receive a request via a user interface of an online marketplace application from a seller to identify a co-shipper for the seller in an online marketplace,
access marketplace data to identify one or more other sellers listing a same item as the seller,
access performance data from the identified one or more other sellers,
rank the identified one or more other sellers as co-shippers based on the marketplace and performance data,
generate a recommendation for co-shippers to the seller based on the ranked identified one or more other sellers, and
present the recommendation for co-shippers to the seller in the user interface of the online marketplace application.

2. The system of claim 1, further comprising:
a relationship management engine configured to:
receive a selection of a recommended co-shipper from the seller, and
form a co-shipping relationship between the selected co-shipper and the seller, the selected co-shipper to ship to the same item to a buyer of the seller.

3. The system of claim 1, wherein the co-shipper recommendation engine is configured to identify the one or more other sellers within a geographic boundary associated with previous buyers of the seller.

4. The system of claim 1, wherein the co-shipper recommendation engine is configured to identify the one or more other sellers having performance data exceeding a performance threshold.

5. The system of claim 1, wherein the performance data comprises customer feedback and shipping timeliness.

6. The system of claim 1, wherein the co-shipper recommendation engine is configured to identify the one or more other sellers having marketplace data exceeding a marketplace threshold.

7. The system of claim 1, wherein the marketplace data comprises at least one selection from the group comprising inventory size for the same item sold by the seller, sales volume, geography of customer demands for the same item, and existing shipping relationships with the seller.

8. The system of claim 1, wherein the co-shipper recommendation engine is configured to compute a co-shipment ranking score for each identified one or more sellers based on the marketplace and performance data, and to generate the recommendation for co-shippers based on the co-shipment ranking score.

9. The system of claim 2, wherein the relationship management engine comprises:
a co-shipper performance module configured to access the performance data of the selected co-shipper in the online marketplace,
the relationship management engine configured to adjust the co-shipping relationship between the selected co-shipper and the seller based on the performance data of the selected co-shipper.

10. The system of claim 9, wherein the relationship management engine is configured to:
terminate the co-shipping relationship between the selected co-shipper and the seller based on the performance data of the selected co-shipper falling below a performance threshold.

11. A method for a trusted fulfillment agent network system comprising:
receiving a request via a user interface of an online marketplace application from a seller to identify a co-shipper for the seller in an online marketplace;
accessing marketplace data to identify one or more other sellers listing a same item as the seller;
accessing performance data from the identified one or more other sellers;
ranking, using a hardware processor of a machine, the identified one or more other sellers as co-shippers based on the marketplace and performance data;
generating a recommendation for co-shippers to the seller based on the ranked identified one or more other sellers; and
presenting the recommendation for co-shippers in the user interface of the online marketplace application to the seller.

12. The method of claim 11, further comprising:
receiving a selection of a recommended co-shipper from the seller; and
forming a co-shipping relationship between the selected co-shipper and the seller, the selected co-shipper to ship to the same item to a buyer of the seller.

13. The method of claim 11, further comprising:
identifying the one or more other sellers within a geographic boundary associated with previous buyers of the seller.

14. The method of claim 11, further comprising:
identifying the one or more other sellers having performance data exceeding a performance threshold.

15. The method of claim 11, wherein the performance data comprises customer feedback and shipping timeliness.

16. The method of claim 11, further comprising:
identifying the one or more other sellers having marketplace data exceeding a marketplace threshold.

17. The method of claim 11, wherein the marketplace data comprises at least one selection from the group comprising inventory size for the same item sold by the seller, sales volume, geography of customer demands for the same item, and existing shipping relationships with the seller.

18. The method of claim 11, further comprising:
computing a co-shipment ranking score for each identified one or more sellers based on the marketplace and performance data; and
generating a recommendation for co-shippers based on the co-shipment ranking score.

19. The method of claim 11, further comprising:
accessing performance data of the selected co-shipper in the online marketplace; and
adjusting the co-shipping relationship between the selected co-shipper and the seller based on the performance data of the selected co-shipper.

20. A non-transitory computer-readable storage medium storing a set of instructions that, when executed by at least one processor of a machine, cause the machine to perform operations comprising:
receiving a request via a user interface of an online marketplace application from a seller to identify a co-shipper for the seller in an online marketplace;
accessing marketplace data to identify one or more other sellers listing a same item as the seller;
accessing performance data from the identified one or more other sellers;
ranking the identified one or more other sellers as co-shippers based on the marketplace and performance data;
generating a recommendation for co-shippers to the seller based on the ranked identified one or more other sellers; and
presenting the recommendation for co-shippers in the user interface of the online marketplace application to the seller.
